(19) United States
(12) Patent Application Publication
(10) Pub. No.: US 2008/0207978 A1
(43) Pub. Date: Aug. 28, 2008

(54) PROTECTIVE REUSE SYSTEM AND METHOD FOR IMPACTED SURFACES

(76) Inventors: Gary R. Brown, Sewell, NJ (US); Lawrence W. Bily, Plymouth Meeting, PA (US); Kevin Traynor, Downingtown, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/677,877

(22) Filed: Feb. 22, 2007

(51) Int. Cl. B09B 5/00

(52) U.S. Cl. 588/249

(57) ABSTRACT

A system and method for remediating contaminated surfaces in order to reoccupy sites in which such impacted surfaces are contained is disclosed. The systems and methods include forming a first barrier substantially over a surface, the first barrier comprising a first solvent-resistant coating and having a first color, forming a second barrier substantially over the first barrier, the second barrier comprising a second solvent-resistant coating and having a second color, and providing an overlay over the second barrier, the overlay comprising an upper covering, a lower covering and a plurality of support members, wherein each of the plurality of support members have a distal end and proximal end, and the support, members are connected to the upper covering at the distal end, and to the lower covering at the proximal end. Utility lines, telephone line, cable cords, ductwork, etc. running within the overlay do not come in contact with the first or second barriers or PCB-impacted surface, at the same time remaining out of sight of occupants of the remediated building or premises.

### FIELD OF INVENTION

The invention relates generally to the treatment of impacted surfaces and more specifically to systems and methods for remediation of contaminated surfaces to reoccupy sites in which such impacted surfaces are contained.

### BACKGROUND OF THE INVENTION

Impacted or contaminated floors and surfaces, concrete in particular, have an adverse effect on the locations, spaces, building and/or sites within which such contaminated floors are situated. Occupants have traditionally been unable to reoccupy such areas and locations for commercial and residential use without utilizing costly clean-up procedures and remedies of removing the impacted concrete or a portion of the impacted concrete.

Generally, a variety of chemicals that have impacted floor surfaces are found to be hazardous to humans. Some of these chemicals have been used in a variety of industrial and commercial applications, the chemicals including but not limited to xenobiotic compounds including PCBs and other semi-volatile, volatile and metal compounds. In particular, xenobiotic compounds, which would include PCBs, possess molecular structures not recognized by microbial enzymes. As a consequence these compounds are highly resistant to degradation by microbial enzymes. PCBs compounds, in particular, typically consist of a biphenyl ring structure with chlorinated substitutions. Prior to the ban on PCBs in the United States, PCBs were used on a variety of commercial and industrial applications including lubricants and flame retardants.

Typically, during industrial and commercial applications, these hazardous chemicals inadvertently or accidentally contacted the floor or other surfaces where these applications were applied or utilized (normally within a building or plant). After contacting the floor or other surface, these chemicals would generally lay on top of the floor and were eventually absorbed into the floor, which generally would be comprised of concrete. While the floor could be wiped with solvent-soaked pads or other absorptive materials to remove hazardous chemicals resting on top of the contaminated surface (or at the surface level), such wiping could not ensure that the chemicals absorbed in the floor would not leach back to the surface.

In other words, chemicals present in areas of higher concentration below the surface would tend to diffuse to areas of lower chemical concentration at the floor surface. The reason why the floor surface would be at a chemically lower concentration is because of absorptive materials and the like removing chemicals at the surface. Accordingly, wiping contaminated surfaces with solvent pads and absorptive materials has its obvious drawbacks.

With specific regard to PCBs, under current law, floor surfaces are presumed to be impacted at PCB concentrations greater than 10 μg/100 cm². In addition, under federal and state law and/or local ordinances, marks or signs are many times required to be affixed to the site. Such signs or marks warn and forbid occupancy due to the presence of impacted/contaminated surfaces. Marks for PCB impacted areas must be installed in easily visible locations per 40 CFR 741.45.

Traditionally, the way to treat contaminated sites is to either (1) remove the impacted concrete or (2) remove both the non-impacted and impacted concrete. The reason for partial or complete removal of the concrete is that current technology is unable to substantially remove or desorb the hazardous substances from the concrete without destroying or removing the concrete itself. Through a partial removal process, the impacted surface of concrete (typically the layer of concrete that is substantially contaminated) can be scaled or scraped off using mechanical force, including sand blasting. However, the removing of impacted surfaces such as entire sections of floor could adversely impact the structural integrity of the building in which they are housed.

In addition, the costs of cleanup can be substantial, which typically results in a large amount of contaminated waste. The contaminated waste can be considerable, sometimes more than that of the stripped concrete alone (i.e., the contaminated waste would not only contain, the stripped concrete but may also contain the contaminated processing material). This contaminated waste must also be further processed and stored in a TSCA (for PCBs) or hazardous waste site. In addition, new concrete must, in many instances, be filled in the place of the contaminated and/or removed concrete.

Other methods have been implemented to remedy impacted floor surfaces. Chemical applications have been, utilized to neutralize or remove the hazardous chemicals. The use of such chemical applications, however, suffer similar drawbacks as large amounts of contaminated materials could result in the chemical applications. In other words, similar to the drawbacks in the removal or partial removal of contaminated concrete, the total amount of the final contaminated material may exceed the amount of stripped concrete alone.

Accordingly, attempts to treat the hazardous chemicals absorbed into the concrete are often times prohibitively expensive and impractical.

### SUMMARY OF THE INVENTION

It is therefore an object of the present invention to provide a system and method to treat impacted surfaces.

It is also an object of the present invention to provide a system and method to remediate chemically contaminated surfaces to reoccupy sites in which such chemically contaminated surfaces are located.

These and other methods are taught by the present invention, which in one aspect is a process for treating surfaces where a first barrier is formed substantially over the surface. In one embodiment, the surface is a floor, more preferably, a concrete floor. The first barrier is preferably comprised of a first solvent-resistant coating and has a first color. Next, a second barrier is substantially formed over the first barrier. The second barrier is preferably comprised of a second solvent-resistant coating and has a second color. Then an overlay is provided over the second barrier. The overlay has an upper covering, a lower covering and more than one support members. Each of the support members has a distal end and proximal end. The support members are connected to the upper covering at the distal end and to the lower covering at the proximal end. The process may include one or more steps of washing and rinsing the surface prior to the coating application.

In one embodiment, the surface comprises a contaminated surface, and more preferably, a PCB-impacted surface. Also, the first solvent-resistant coating and the second solvent-resistant coating can be selected from industry-standard materials such as Sherwin Williams® Armor seal 700 HS® or the equivalent as included in the final design of the coating system or a combination thereof. In a preferred embodiment, the upper covering is positioned at least approximately 5 inches above the surface.

In another aspect, the present invention is a process for remediation of an area where a surface that is located in that area is washed and rinsed. In a preferred embodiment, surface is a contaminated surface, and more preferably, a PCB-impacted surface. The surface is then dried for a predetermined period of time. The first barrier can be a first solvent-resistant coating and can have a first color. A second barrier is formed substantially over the first barrier. The second barrier can be a second solvent-resistant coating and can have a second color. Then an overlay is provided over the second barrier. The overlay includes an upper covering, a lower covering and a plurality of support members. Each of the plurality of support members has a distal end and proximal end. The support members are connected to the upper covering at the distal end, and to the lower covering at the proximal end.

The process can optionally include the step of providing a PCB management plan. The PCB management plan includes but is not limited to a description of the nature of the contaminated surface, procedures in the event that the contaminated surface is disturbed, and handling and disposal requirements of waste materials. The process can also include providing an aperture through a floor (which incorporates the contaminated surface) prior to forming the first barrier. A tube may be positioned in the aperture to enable passage through the aperture by objects such as telephone lines, cable lines and the like. Such objects would be prevented from coming in contact with concrete by virtue of being substantial or surrounded by the tube. In one embodiment, the tube is metal, and more preferably, steel ductwork.

In yet another aspect, the present invention is a process for remediation of a location having contaminated surfaces, which includes washing and rinsing a contaminated surface of a floor. The contaminated surface is allowed to dry for a predetermined period of time. In one embodiment, the contaminated surface is dried, for a period of 24 hours. An aperture is then provided through the floor containing the contaminated surface. The aperture can houses a tube, which in one embodiment is steel ductwork. Next, a first barrier is formed substantially over the contaminated surface. The first barrier can be a first solvent-resistant coating and can have a first color. A second barrier can then be formed substantially over the first barrier. The second barrier can be a second solvent-resistant coating and can have a second color. Then an overlay is provided over the second barrier. The overlay can include an upper covering, a lower covering and a plurality of support members. Each of the plurality of support members has a distal end and proximal end, and the support members are connected to the upper covering at the distal end, and to the lower covering at the proximal end. The upper covering is positioned at least approximately five inches above the contaminated surface. A PCB management plan is also provided.

In one embodiment, the contaminated surface is a PCB-impacted surface. The first solvent-resistant coating and the second solvent-resistant coating can be selected from the selected final system coating design or any such combination.

### BRIEF DESCRIPTION OF THE DRAWINGS

FIG. 1 is a flow chart of one embodiment of the present invention.

FIG. 2 is a perspective view of the impacted surface, the first barrier and the second barrier of one embodiment of the present invention.

FIG. 3 is a perspective view of one embodiment of the present invention.

FIG. 4 is a semi-perspective view illustrating the aperture and casting according to one embodiment of the present invention.

### DETAILED DESCRIPTION OF THE INVENTION

The present invention is directed at the remediation of contaminated surfaces and, in particular, PCB impacted surfaces. The remediation processes of the present invention allows for the treatment and reoccupation of sites (such as buildings, plants and the like) for residential and commercial use that may otherwise have been unoccupied due to the presence of contaminated surfaces. The presence of visible signage typically corresponds to a lack of occupancy at a location with contaminated surfaces. Thus, the remediation process of the present invention avoids visible signage during normal occupancy, but notifies maintenance workers to avoid inadvertent direct contact and exposure.

As a result of commercial and industrial applications, surfaces within a building or at a location can be impacted with chemicals or chemical compounds. Typically, these surfaces are concrete floors; however, it is understood that these surfaces can be comprised of other materials with the capacity to absorb materials including but not limited to stone, tile and the like. These chemical compounds can, in turn, be hazardous to humans. This can include but is not limited to xenobiotic compounds and other volatile, semi-volatile and metal containing materials. In a preferred embodiment, the surface is contaminated with PCB (polychlorinated biphenyl), which falls under the class of xenobiotic compounds. It is understood, however, that the surface does not necessarily have to be contaminated or impacted at all with chemicals hazardous to humans.

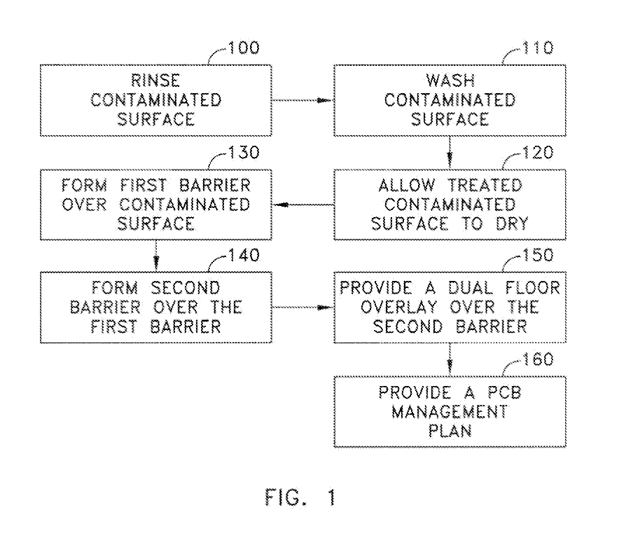

Referring to FIG. 1, in one embodiment the surface is prepped using a rinse and wash procedure, preferably a double rinse and wash procedure. Typically, the rinse in step 100 comprises covering all or substantially all of the contaminated surface with organic solvent. Preferably, the solvent chosen is one in which PCBs are soluble to at least 5 percent by weight. If the surface is rough, it is preferred to scrub the contaminated surface prior to the rinse step 100 so that the surface is very wet for 1 minute. If the surface is relatively smooth, it is preferred to wipe the smooth surface with a solvent-soaked and disposable absorbent pad (each 900 cm², i.e., one square foot, should be wiped for 1 minute). The absorbent material should be applied to the solvent until there is no visible trace of the solvent.

During the wash in step 110, clean rinse solvent is applied to the contaminated surface in order to wet the entire contaminated surface or substantially all of the surface significantly for 1 minute. The solvent is then drained from the surface and contained in a proper housing. The residual solvent is then wiped off the surface using an absorbent pad until there is no visible trace of liquid on the surface. This rinse and wash procedure can be then utilized again via a double rinse and wash procedure. After the rinse and wash procedure is completed, the surface in step 120 is allowed to dry for a predetermined period of time. Such as period of time can depend on a number of factors including but not limited to the type of solvent(s) used and the wash and rinse procedures. In a preferred embodiment, however, this period is no less than 24 hours.

After the optional rinse and wash procedure is completed, the present invention comprises forming a first barrier substantially over the PCB impacted surface in step 130. After the first barrier is formed over the impacted surface and is allowed to substantially dry, a second barrier is formed over the first barrier and impacted surface in step 140. Finally, a dual floor overlay is provided over the second barrier in step 150. Optionally, a PCB management plan is provided in step 160. The first barrier, second barrier, dual floor overlay and PCB management plan will be described in greater detail below.

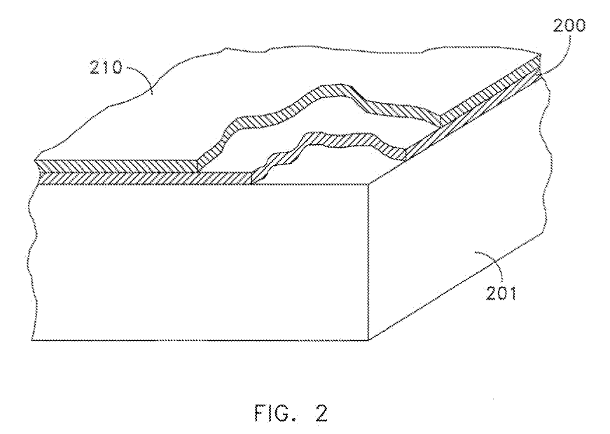

Referring to FIG. 2, the first barrier 200 is comprised of a first solvent-resistant and wafer-repellant coating including but not limited to epoxy and cementitious coatings, among others. The first barrier 200 may be applied to the impacted surface 201 through any of a number of suitable methods including but not limited to brushing, spraying, rolling, among others. In one preferred embodiment, the first barrier 200 is comprised of Sherman Williams® Armor Seal 700 HS®. It is understood, however, that other solvent-resistant and water-repellant materials may be utilized as are generally known and available. The first barrier 200 is also comprised of a characteristic color or a first color.

The second barrier 210 can likewise be comprised of a solvent-resistant and water-repellant coating including but not limited to epoxy, cementitious coatings, among others. In one embodiment, the second barrier 210 is comprised of the same coating as that of the first barrier 200. The second barrier 210 is also comprised of a characteristic color or second color. Likewise, the second barrier 210 can be applied to the first barrier 200 through any of a number of suitable methods including but not limited to brushing, spraying, rolling and the like.

The second color should contrast with the first, color. For example, the first color can be red, while the second color can be white, thus providing the contrast. By providing contrasting colors between the first color and second color, there is a visual indication of “wear-through” or loss of integrity of the second barrier 210. It then becomes easy for an occupant, person, worker or the like to identify “wear-through” of one or both barriers. The first barrier 200 and second barrier 210 can also be marked with precautions, in Spanish and in English. Preferably, multiple markings composed of the term M_{1L}, are added at spaced intervals along the surface area of both barriers 200, 210.

Once the second barrier 210 is allowed to dry or substantially dry, a dual floor overlay 220 is then provided over the second barrier 210. The dual floor overlay 220 cars be secured or connected to the second barrier 210, first barrier 200 and impacted surface 201 using a variety of methods including fastening with bolts, screws or the like. In one embodiment, the dual floor overlay 220 is simply placed over the second barrier 210 with the weight of the of dual floor overlay 220 providing sufficient force to prevent the overlay 220 from moving or shifting relative the impacted surface 201.

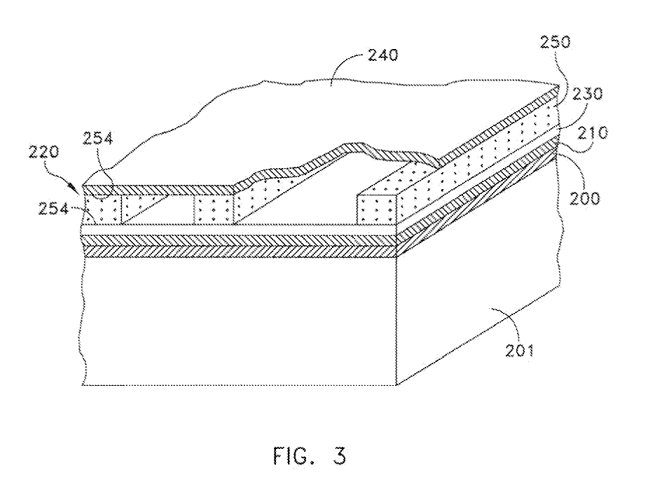

Referring to FIG. 3, the dual floor overlay 220 comprises an upper covering 230, a lower covering 240 and two or more support members 250. The upper covering 230 can be comprised of any of a number of materials including wood, wood composites, steel, steel or metal alloys, plastic, concrete or any material suitable to withstand the weight of materials, equipment and people over the dual floor 220. In a preferred embodiment, the upper covering 230 is comprised of carpeting or floor file over an under-laminate such as plywood, hardibacker or the like. The lower covering 240 can likewise be comprised of a variety of materials including wood, wood composites, steel, steel or metal alloys, plastic, concrete or any other suitable material. In a preferred embodiment, the lower covering 240 is comprised of plywood, more preferably, plywood at least ½ inch thick.

Each of the support members 250 has two ends, a distal end 252 and proximal end 254, where the opposing ends are connected to the upper covering 230 and lower covering 240, respectively. In other words, for each support member 250, the distal end 252 is connected to the upper covering 230 and the proximal end 254 is connected to the lower covering 240. The ends 252, 254 of each support member 250 can be connected to the coverings 230, 240 using adhesives, nails, screws or any other suitable device or material.

The overall structure of the dual floor overlay 220 is such that there is spacing between the support member 250, providing horizontal access in the X and Y directions as well as limited access in the vertical direction (which would also include one or more apertures 260 through the impacted surface 201, which will be described in greater detail below). This would allow for utility lines, telephone lines, cable cords, ductwork, plumbing, etc. to run between the upper covering 230 and lower covering 240 without being visible from outside of the dual floor overlay 220.

By allowing utility lines, telephone lines, cable cords, ductwork, plumbing, etc. to travel within the dual floor overlay 220, i.e., under the upper covering 230 and over the lower covering 240, such the utility lines, telephone lines, etc. do not come in contact with the first or second barriers 200, 210 or impacted surface 201, which is preferably a PCB-impacted surface. At the same time, such the utility lines, telephone lines, etc. remain out of sight of occupants of the remediated building.

In one embodiment, the support members 250 are joist-like elements that run lengthwise across an entire length (or substantially an entire length) of the upper or lower covering 230, 240. In such an embodiment, holes are provided through the width of the support members 250 along its length spaced at predetermined locations. For example, holes can be provided through the width of support member 250 every 12 inches or even every 24 inches. The holes are sized such that the structural integrity of the support members 250 to support people, machines, objects is not compromised, while at the same time allowing cable lines, telephone lines, etc. to easily pass therethrough. In one embodiment, holes are sized to about 2-3 inches in diameter. Utility lines, telephone lines, cable lines, etc. are thus capable of being run widthwise within dual floor overlay 220 through the holes provided along the length of the support member 250, as well as lengthwise along the support member 250.

In an alternative embodiment, the support members 250 are shortened joist-like elements that run a portion of the length of the upper covering 230 or lower covering 240. In such an embodiment, utility lines, cable lines and the like can traverse widthwise between the upper and lower coverings 230, 240 around the shortened joist-like elements. Due to the shortened nature of the joist-like elements, such joist-like elements do not significantly impede navigation of the utility lines and the like. In another embodiment, the support members 250 comprise columns having diameters of about 2 inches to about 12 inches, spaced apart from each other. The composition of the joist can be any suitable material capable of supporting at least a floor including but not limited to wood, wood composites, steel, steel or metal alloys, plastic, concrete.

It is understood that the support member 250 can comprise any of the above referenced embodiments or any combination thereof. It is also understood that the support member 250 can comprise any of a number of different embodiments not described above, so long as the support member 250 is connected to the upper covering 230 and lower covering 240 and allows cable lines, telephone lines, electrical lines, plumbing and the like to traverse within the dual floor system 220.

The height of the dual floor overlay 220 (measured from the lower covering 240 vertically to the upper covering 230) is between about 5 inches and about 8 inches, but can be raised higher or lowered depending on the particular needs of the location or building. More preferably, the height of the dual floor overlay 220 is about 5 inches. For example, if a user desires to have more or thicker utility lines, thicker plumbing, or thicker ductworks through the dual floor overlay 220, the user can adjust the height of the dual floor overlay 220 to properly accommodate such items accordingly. Also, the height of the dual floor overlay 220 should be high enough such that a drill can be utilized with respect to the upper covering 230 without breaching the first and second barriers 200, 210 and exposing the PCB impacted concrete 201. For example, when drilling a screw though the upper covering 230 to secure an item or object thereto, the height of the upper covering 230 should be greater than the length of the screw and securing bit of the drill. The screw would thus not come in contact with the first barrier 200 or second barrier 210, causing exposure of the PCB impacted concrete 201.

The process can optionally include providing a PCB management plan. The PCB management plan can include but is not limited to a description of the nature of the contaminated surface, procedures in the event that the contaminated surface is disturbed, and handling and disposal requirements of waste materials. The PCB management plan can also contain procedures relating to restrictions on accessing the PCB impacted concrete floors. Safe work and work permit procedures can be described in the PCB management plan as well. In addition, utility rooms can be posted with instructions on how to run utility lines, plumbing, cable lines, etc. in order to avoid impacted floor disturbance. These instructions can also contain statements that no disturbance of impacted floors is permitted without a written work permit issued by building management.

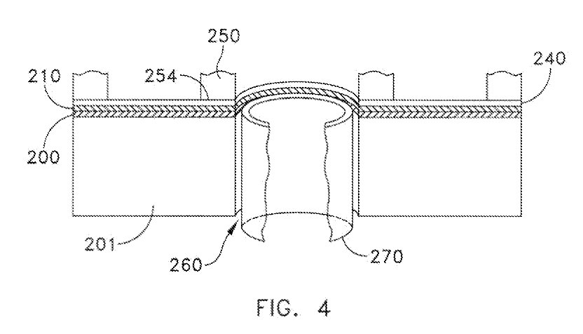

Referring to FIG. 4, the present invention can also include providing an aperture 260 through the impacted surface 201. The aperture 260 can be of any configuration (e.g., square, rectangle, etc.). Preferably, the aperture 260 is created prior to forming the first barrier 200. One or more apertures 260 are provided vertically through the impacted surface 201 at predetermined areas. Preferably, more than two apertures 260 are provided per building level, assuming more than one level or story. Utility lines, telephone line, cable cords, etc. can run vertically through the apertures 260, and typically would not come into contact with the first barrier 200, second barrier 210 or PCB impacted surface 201.

Precautions are taken to eliminate any contact of the items traversed through the aperture 260 with the impacted surface 201. One such precaution is to use a casing 270 within the interior of the aperture 260. The casing 270 prevents the utility lines, telephone lines, etc. from coming into direct contact with the impacted surface 260. In this embodiment, the casing 270 is comprised of a durable material and is tubular in shape with an opening that extends therethrough. The exterior surface of the casing 270 secured to any of the dual floor overlay 220, the second barrier 210 or the impacted surface 201 or a combination thereof, such that the casing 270 is substantially stable and free from movement relative to the aperture 260. This allows for utility lines, telephone lines, cable cords and the like to traverse vertically through the impacted surface 201 without coming directly into contact with the impacted surface 201. In a preferred embodiment, the tube is metal, and in particular, steel ductwork.

Accordingly, the present invention generally protects against inadvertent contact with hazardous chemical such as PCBs and the like (which in most instances is found in the concrete surfaces). The current invention provides for occupant protection within the remediated buildings, locations and sites that house surfaces impacted by PCBs. This is accomplished, in part, through pathway elimination of PCB impacted surfaces. The current invention also provides utility workers, construction workers, maintenance workers, with notice of and protection from PCB impacted surfaces in buildings and locations having PCB impacted surfaces. Such workers during the course of routine maintenance such as drilling or nailing are protected not only by the dual floor overlay 220 and barriers 200, 210 over the PCB impacted surfaces 201, but also though guidance from the PCB Management Plan document. The current invention would allow for the future installation of utility lines, telephone lines, plumbing pipes, etc. generally without exposure to PCB impacted surfaces. The current invention also provides for disposal requirements for concrete waste materials generated by future building renovation and demolition activities (via the PCB management plan, posted signage and the like).

Whereas the present invention has been described in relation to the accompanying drawings, it should be understood that other and further modifications, apart from those shown of suggested herein, may be made within the spirit and scope of the present invention. It is also intended that all matter contained in the foregoing description or shown in the accompanying drawings shall be interpreted as illustrative rather than limiting.

What is claimed is:

1. A process for treating surfaces comprising the steps of:
forming a first barrier substantially over a surface, the first barrier comprising a first solvent-resistant coating and having a first color;
forming a second barrier substantially over the first barrier, the second barrier comprising a second solvent-resistant coating and having a second color; and
providing an overlay over the second barrier, the overlay comprising an upper covering, a lower covering and a plurality of support members, wherein each of the plurality of support members has a distal end and proximal end, and the support members arc connected to the upper covering at the distal end, and to the lower covering at the proximal end.

2. The process of claim 1, wherein the surface comprises a contaminated surface.

3. The process of claim 2, wherein the contaminated surface comprises a PCB-impacted surface.

4. The process of claim 1, further comprising the step of washing and rinsing the surface.

5. The process of claim 1, wherein the first solvent-resistant coating and the second solvent-resistant coating comprise an epoxy-based material, a cementitious material or a combination thereof.

6. The process of claim 1, wherein the upper covering is positioned at least approximately five inches above the surface.

7. A process for remediation of a location comprising the steps of:
washing and rinsing a surface;
allowing the surface to dry for a predetermined period of time;
forming a first barrier substantially over the surface, the first barrier comprising a first solvent-resistant coating and having a first color;
forming a second barrier substantially over the first barrier, the second barrier comprising a second solvent-resistant coating and having a second color; and
providing an overlay over the second barrier, the overlay comprising an upper covering, a lower covering and a plurality of support members, wherein each of the plurality of support members have a distal end and proximal end, and the support members are connected to the upper covering at the distal end, and to the lower covering at the proximal end.

8. Process of claim 7, wherein the surface comprises a contaminated surface.

9. Process of claim 8, wherein the contaminated surface comprises a PCB-impacted surface.

10. The process of claim 7, wherein the first solvent-resistant coating and the second solvent-resistant coating comprise an epoxy-based material, a cementitious material or a combination thereof.

11. The process of claim 7, wherein the upper covering is positioned at least approximately five inches above the surface.

12. The process of claim 8, further comprising the step of providing a PCB management plan.

13. The process of claim 12, wherein the PCB management plan comprises a description of the nature of the contaminated surface, procedures in the event that the contaminated surface is disturbed, and handling and disposal requirements of waste materials.

14. The process of claim 8, further comprising the step of providing an aperture through a floor containing the contaminated surface prior to forming the first barrier, wherein the aperture houses a tube.

15. The process of claim 14, wherein the tube comprises steel ductwork.

16. The process of claim 7, wherein the predetermined period of time is 24 hours.

17. A process for remediation of a location having contaminated surfaces comprising the steps of:
washing and rinsing a contaminated surface of a floor;
allowing the contaminated surface to dry for a predetermined period of time;
providing an aperture through the floor containing the contaminated surface, wherein the aperture houses a tube;
forming a first barrier substantially over the contaminated surface, the first barrier comprising a first solvent-resistant coating and having a first color;
forming a second barrier substantially over the first barrier, the second barrier comprising a second solvent-resistant coating and having a second color;
providing an overlay over the second barrier, the overlay comprising an upper covering, a lower covering and a plurality of support members, wherein each of the plurality of support members have a distal end and proximal end, and the support members are connected to the upper covering at the distal end, and to the lower covering at the proximal end;
wherein the upper covering is positioned at least approximately five inches above the contaminated surface; and
providing a PCB management plan.

18. The process of claim 17, wherein the contaminated surface comprises a PCB-impacted surface.

19. The process of claim 17, wherein the first solvent-resistant coating and the second solvent-resistant coating comprise an epoxy-based material, a cementitious material or a combination thereof.

20. The process of claim 17, wherein the tube comprises steel ductwork.

21. The process of claim 17, wherein the predetermined period of time is 24 hours.

22. A system for remediation of a location having contaminated surfaces comprising:
a first barrier formed substantially over a contaminated surface, the first barrier comprising a first solvent-resistant coating and having a first color;
a second barrier formed substantially over the first barrier, the second barrier comprising a second solvent-resistant coating and having a second color; and
An overlay provided over the second barrier, the overlay comprising an upper covering, a lower covering and a plurality of support members, wherein each of the plurality of support members have a distal end and proximal end, and the support members are connected to the upper covering at the distal end, and to the lower covering at the proximal end.

23. The system for remediation of claim 22, further comprising a PCB management plan.
